(19) United States
(12) Patent Application Publication
(10) Pub. No.: US 2024/0282180 A1
(43) Pub. Date: Aug. 22, 2024

(54) INFORMATION PROCESSING APPARATUS, NON-TRANSITORY COMPUTER READABLE MEDIUM, AND INFORMATION PROCESSING METHOD

(71) Applicant: FUJIFILM Business Innovation Corp., Tokyo (JP)

(72) Inventors: Tomoya NISHIDA, Kanagawa (JP); Ryoko SAITOH, Kanagawa (JP); Yoshifumi BANDO, Kanagawa (JP); Hideki YAMASAKI, Kanagawa (JP)

(73) Assignee: FUJIFILM Business Innovation Corp., Tokyo (JP)

(21) Appl. No.: 18/364,062

(22) Filed: Aug. 2, 2023

(30) Foreign Application Priority Data
Feb. 16, 2023 (JP) 2023-022706

(51) Int. Cl. G07F 19/00; G06F 3/01; G06F 3/0487

(52) U.S. Cl. CPC G07F 19/207; G06F 3/013; G06F 3/0487; G07F 19/206

(57) ABSTRACT

An information processing apparatus includes a processor configured to: receive line-of-sight information indicating a position to which a user directs the user's line of sight, and operation information input by the user operating operation buttons; and authenticate the user with the received line-of-sight information and the received operation information.

### CROSS-REFERENCE TO RELATED APPLICATIONS

This application is based on and claims priority under 35 USC 119 from Japanese Patent Application No. 2023-022706 filed Feb. 16, 2023.

### BACKGROUND

### (i) Technical Field

The present disclosure relates to an information processing apparatus, a non-transitory computer readable medium, and an information processing method.

### (ii) Related Art

Japanese Unexamined Patent Application Publication No. 2009-187443 discloses an automated teller machine. The automated teller machine includes a screen display unit configured to display a screen corresponding to processing in the automated teller machine on a display, and an eye tracking unit configured to detect viewpoint coordinates of a user on the display by analyzing an eyeball image of the user. The automated teller machine further includes a user interface unit configured to refer to the viewpoint coordinates detected by the eye tracking unit and specify an image on which the user's viewpoint is being focused from among images included in the screen displayed on the display by the screen display unit. The automated teller machine additionally includes a controller configured to, when executing a PIN code input process, instruct the screen display unit to display a keyboard screen including a plurality of key images corresponding to different characters, and obtain characters corresponding to key images specified by the user interface unit as characters to be used in the PIN code.

Japanese Unexamined Patent Application Publication No. 2020-003853 discloses a password authentication apparatus. The password authentication apparatus includes a display device having a display screen, and a display controller configured to display a plurality of input key groups, each being composed of a plurality of software keys for entering a password for user authentication, on the display screen. The password authentication apparatus further includes an input operation unit that is provided in a location separate from the plurality of input key groups, and that is capable of selecting software keys on the display screen and entering a password by being operated by a user, and a line-of-sight detector configured to detect a line-of-sight direction of the user operating the input operation unit. The password authentication apparatus additionally includes an operation target specifying unit configured to specify an input key group ahead of the user's line of sight from among the plurality of input key groups based on the line-of-sight direction detected by the line-of-sight detector. The password authentication apparatus yet further includes a password obtaining unit configured to obtain a password entered through the input operation unit, as if an operation performed on the input operation unit is an operation performed on an input key group specified by the operation target specifying unit. The password authentication apparatus also includes a password authentication unit configured to authenticate a password obtained by the password obtaining unit.

Japanese Unexamined Patent Application Publication No. 2006-235694 discloses a cryptographic code authentication system used for electronic commerce in which various transactions are performed by accessing a server device using a card from an automated cash transaction machine. The cryptographic code authentication system determines the validity of the card at the time of a transaction depending on a combination of a numerical cryptographic code given to the card with a pre-registered English character cryptographic code managed on the server device side.

As a method for authenticating a user, there is a method of determining whether a password entered by operating operation buttons matches a predetermined password. However, there is a possibility that someone else other than the user impersonates the user by pecking at the user operating the operation buttons, such as numbers entered by operating a numeric keypad.

### SUMMARY

Aspects of non-limiting embodiments of the present disclosure relate to an information processing apparatus, a non-transitory computer readable medium, and an information processing method capable of preventing someone else other than a user from impersonating the user, even in the case where someone else peeks at the user operating operation buttons.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a processor configured to: receive line-of-sight information indicating a position to which a user directs the user's line of sight, and operation information input by the user operating operation buttons, and authenticate the user based on the received line-of-sight information and the received operation information.

### BRIEF DESCRIPTION OF THE DRAWINGS

Exemplary embodiments of the present disclosure will be described in detail based on the following figures, wherein:

FIG. 1 is a schematic diagram illustrating an example of the hardware configuration of an information processing apparatus according to an exemplary embodiment;

FIG. 2 is a flowchart illustrating an example of the flow of information processing in an information processing apparatus according to a first exemplary embodiment;

FIG. 3 includes schematic diagrams illustrating an example of the case in which operation information is set before line-of-sight information in setting combination information according to the first exemplary embodiment;

FIG. 4 includes schematic diagrams illustrating an example of the case in which line-of-sight information is set before operation information in setting combination information according to the first exemplary embodiment;

FIG. 5 is a schematic diagram illustrating an example of the case in which line-of-sight information is set between items of operation information in setting combination information according to the first exemplary embodiment;

FIG. 6 is a schematic diagram illustrating an example of the case in which simultaneous information is included in setting combination information according to the first exemplary embodiment;

FIG. 7 is a flowchart illustrating an example of the flow of information processing in an information processing apparatus according to a second exemplary embodiment;

FIG. 8 includes schematic diagrams illustrating an example of the case in which a central processing unit (CPU) according to the second exemplary embodiment receives line-of-sight information before operation information;

FIG. 9 is a schematic diagram illustrating an example of the case in which the CPU according to the second exemplary embodiment only receives operation information;

FIG. 10 includes schematic diagrams illustrating an example of the case in which the CPU according to the second exemplary embodiment changes the layout of symbols displayed on operation buttons before receiving line-of-sight information;

FIG. 11 includes schematic diagrams illustrating an example of the case in which the CPU according to the second exemplary embodiment changes the layout of symbols displayed on operation buttons when not receiving line-of-sight information;

FIG. 12 is a flowchart illustrating an example of the flow of information processing in an information processing apparatus according to a third exemplary embodiment;

FIG. 13 includes schematic diagrams illustrating an example of the case in which a CPU according to the third exemplary embodiment receives line-of-sight information;

FIG. 14 is a schematic diagram illustrating an example of the case in which the CPU according to the third exemplary embodiment does not receive line-of-sight information;

FIG. 15 is a flowchart illustrating an example of the flow of information processing in an information processing apparatus according to a fourth exemplary embodiment;

FIG. 16 includes schematic diagrams illustrating an example of the case in which a CPU according to the fourth exemplary embodiment simultaneously receives line-of-sight information and operation information;

FIG. 17 includes schematic diagrams illustrating an example of the case in which, after changing the display form of symbols, the CPU according to the fourth exemplary embodiment simultaneously receives line-of-sight information that matches setting line-of-sight information and operation information;

FIG. 18 includes schematic diagrams illustrating an example of the case in which the CPU according to the fourth exemplary embodiment receives line-of-sight information that matches setting line-of-sight information; and

FIG. 19 includes schematic diagrams illustrating an example of the case in which the CPU according to the fourth exemplary embodiment receives line-of-sight information that matches setting line-of-sight information simultaneously as an input of predetermined operation information.

### DETAILED DESCRIPTION

Hereinafter, exemplary embodiments of the present disclosure will be described with reference to the drawings. Note that the same or equivalent components and portions are given the same reference symbols in the drawings. In addition, the dimensional ratios in the drawings are exaggerated for the convenience of the description, and may differ from the actual ratios.

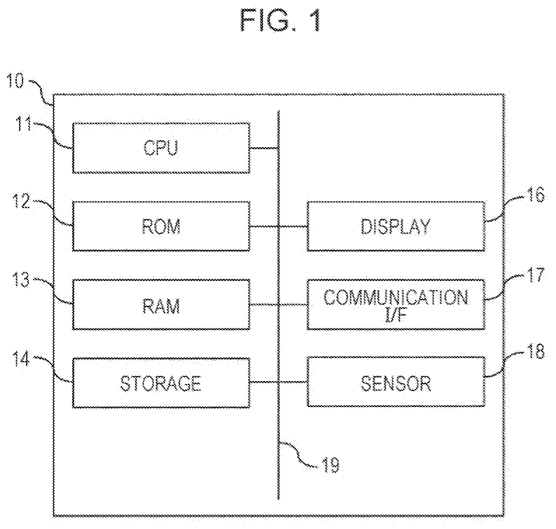

As illustrated in FIG. 1, an information processing apparatus 10 includes the configurations of a central processing unit (CPU) 11, a read-only memory (ROM) 12, a random-access memory (RAM) 13, a storage 14, a display 16, a communication interface (I/F) 17, and a sensor 18. The configurations are communicably connected to each other via a bus 19.

In the present exemplary embodiment, an automated teller machine installed in a financial institution such as a bank is applied as the information processing apparatus 10. However, this is not the only possible example. A cash dispenser may be applied as an information processing apparatus, or any apparatus that performs information processing described below may be applied.

The CPU 11 is a central processing unit, which executes various programs and controls the individual components. That is, the CPU 11 reads programs from the ROM 12 or the storage 14 and executes the programs using the RAM 13 as a workspace. The CPU 11 controls the above-described configurations and performs various types of arithmetic processing in accordance with programs stored in the ROM 12 or the storage 14. In the present exemplary embodiment, an information processing program is stored in the ROM 12 or the storage 14.

The ROM 12 stores various programs and various types of data. The RAM 13, as a workspace, temporarily stores programs or data. The storage 14 includes a storage device such as a hard disk drive (HDD) or a solid state drive (SSD), and stores various programs including an operating system, and various types of data.

The ROM 12 or the storage 14 stores an information processing program. In addition, the ROM 12 or the storage 14 stores a user database. In the user database, setting operation information and setting combination information are stored in association with each authorized user identification (ID) that identifies an authorized user who is able to use the information processing apparatus 10. The setting operation information and the setting combination information are predetermined by the administrator of the information processing apparatus 10 or the like.

The display 16 is, for example, a liquid crystal display, which displays various types of information. In the present exemplary embodiment, the display 16 also functions as an input unit used for performing various inputs by employing a touchscreen system. The display 16 displays operation buttons 16A for a target user who is the user operating the information processing apparatus 10 to input operation information.

In the present exemplary embodiment, numbers from 0 to 9 are displayed as symbols on the operation buttons 16A. However, this is not the only possible example. It is only necessary that symbols such as numbers, characters, or shapes be displayed on the operation buttons 16A.

Note that the display 16 need not function as an input unit. In this case, the information processing apparatus 10 includes, apart from the display 16, a pointing device such as a mouse or operation buttons such as a keyboard.

The communication I/F 17 is an interface for communicating with other devices, and a standard such as Ethernet (registered trademark), Fiber Distributed Data Interface (FDDI), or Wi-Fi (registered trademark) is used.

The sensor 18 is a sensor configured to detect the line of sight of a target user.

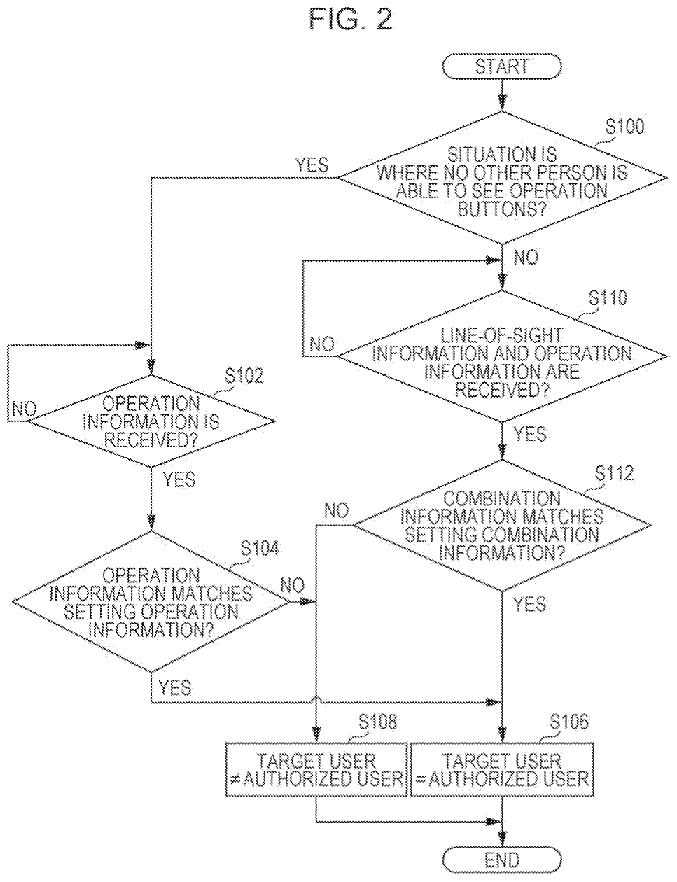

Next, with reference to FIG. 2, the flow of information processing in the information processing apparatus 10 of the present exemplary embodiment will be described. The information processing is performed by the CPU 11 reading the information processing program from the ROM 12 or the storage 14, and expanding and executing it in the RAM 13.

In step S100 in FIG. 2, the CPU 11 determines whether, as a predetermined condition, the condition that no one other than a target user is able to see the operation buttons 16A is satisfied. For example, in the case where there is no apparatus adjacent to the information processing apparatus 10, or in the case where a mechanism is introduced in the display 16 to allow the target user to see different information depending on the angle from which the target user looks into the display 16, the CPU 11 determines that no other person is able to see the operation buttons 16A. In addition, in the case where the information processing apparatus 10 includes a sensor configured to detect a person, and in the case where the sensor detects that there is no other person behind the target user, the CPU 11 determines that the situation is such that no other person is able to see the operation buttons 16A. In the case where the situation is such that no other person is able to see the operation buttons 16A (step S100: YES), the CPU 11 moves to step S102.

In step S102, the CPU 11 waits until receiving operation information input by the target user operating the operation buttons 16A. Operation information is, for example, information combining multiple numbers. On receipt of operation information (step S102: YES), the CPU 11 moves to step S104.

In step S104, the CPU 11 determines whether the operation information received in step S102 matches any setting operation information stored in the user database. In other words, the CPU 11 authenticates the target user only with the received operation information. In the case where the received operation information matches setting operation information (step S104: YES), the CPU 11 moves to step S106. In contrast, in the case where the received operation information does not match setting operation information (step S104: NO), the CPU 11 moves to step S108.

In step S106, the CPU 11 determines that the target user is an authorized user. Note that the CPU 11 may display a screen displaying that the target user is permitted to use the information processing apparatus 10 on the display 16. Then, the information processing ends.

In step S108, the CPU 11 determines that the target user is not an authorized user. Note that the CPU 11 may display a screen displaying that the target user is not permitted to use the information processing apparatus 10 on the display 16. Then, the information processing ends.

Returning to step S100, in the case where the situation is such that someone else is able to see the operation buttons 16A (step S100: NO), the CPU 11 moves to step S110.

In step S110, the CPU 11 waits until receiving line-of-sight information indicating a position to which the target user directs the user's line of sight, and operation information input by the target user operating the operation buttons 16A. Specifically, the CPU 11 waits until receiving line-of-sight information via the sensor 18 and receiving operation information via the operation buttons 16A. In the present exemplary embodiment, the CPU 11 may receive line-of-sight information and operation information at different times or simultaneously. On receipt of line-of-sight information and operation information (step S110: YES), the CPU 11 moves to step S112.

In step S112, the CPU 11 determines whether combination information that combines the line-of-sight information and the operation information in the order received in step S110 matches any setting combination information stored in the user database. In other words, the CPU 11 authenticates the target user with combination information. In the case where the combination information matches setting combination information (step S112: YES), the CPU 11 moves to step S106. In contrast, in the case where the combination information does not match setting combination information (step S112: NO), the CPU 11 moves to step S108.

Note that the predetermined condition is not limited to the condition that no other person is able to see the operation buttons 16A. For example, as the predetermined condition, the condition that the CPU 11 has received operation information within a predetermined time (e.g., within 10 seconds) may be applied. In this case, when the CPU 11 receives operation information within the predetermined time, the target user is authenticated only with the received operation information. In contrast, when the CPU 11 does not receive operation information within the predetermined time, the CPU 11 newly receives line-of-sight information. Then, the CPU 11 authenticates the target user with combination information.

In addition, in the case where the CPU 11 receives line-of-sight information and operation information, it is not necessary to determine whether combination information matches setting combination information. For example, on receipt of line-of-sight information, the CPU 11 determines whether the line-of-sight information matches predetermined setting line-of-sight information. Then, in the case where the received line-of-sight information matches setting line-of-sight information, the CPU 11 receives operation information. The CPU 11 determines whether the received operation information matches predetermined setting operation information. Then, in the case where the received operation information matches setting operation information, the CPU 11 determines that the target user is an authorized user. Note that the information first received by the CPU 11 may be line-of-sight information or operation information.

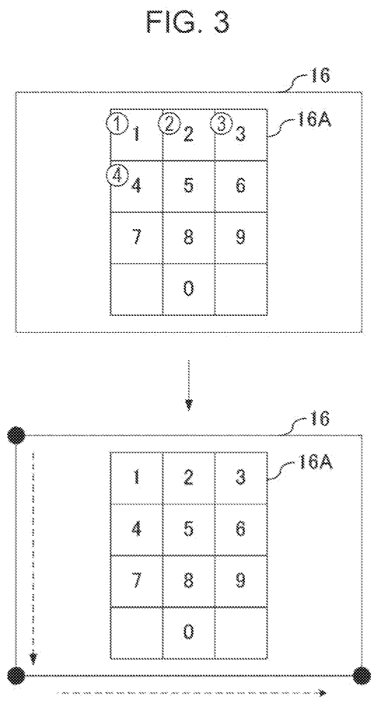

FIG. 3 illustrates an example of the case in which operation information is set before line-of-sight information in setting combination information. For example, as illustrated in the upper diagram of FIG. 3, the CPU 11 displays “1” on the upper left operation button 16A. “2” next to it, and “3” next to it. Then, the CPU 11 displays “4” below “1” on the operation button 16A, “5” next to it, and “6” next to it. Then, the CPU 11 displays “7” below “4” on the operation button 16A, “8” next to it, and “9” next to it. Then, the CPU 11 displays “0” below “8” on the operation button 16A. Then, the CPU 11 first receives “1234” as operation information. Note that, in the upper diagram of FIG. 3, numbers surrounded by circles indicate the order in which the target user has operated the operation buttons 16A.

Then, as illustrated in the lower diagram of FIG. 3, the CPU 11 receives line-of-sight information in the upper left corner of the display 16, then the lower left corner of the display 16, and then the lower right corner of the display 16. In the lower diagram of FIG. 3, dotted arrows indicate the movement of the line of sight of the target user, and black circles indicate positions to which the target user directs the user's line of sight. Then, the CPU 11 authenticates the target user by determining whether combination information that combines line-of-sight information and operation information in the order received matches setting combination information.

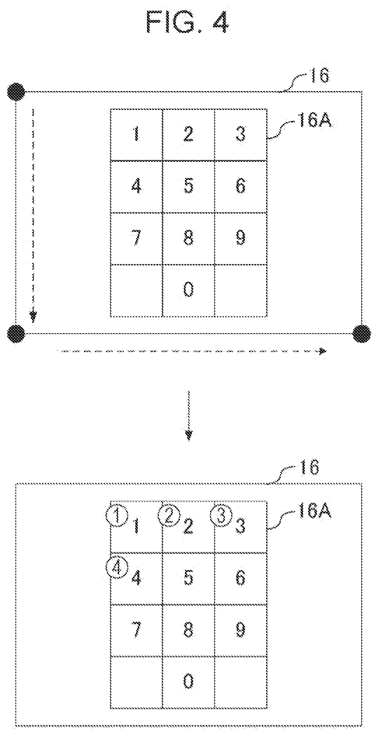

FIG. 4 illustrates an example of the case in which line-of-sight information is set before operation information in setting combination information. For example, as illustrated in FIG. 4, the CPU 11 receives line-of-sight information in the upper left corner of the display 16, then the lower left corner of the display 16, and then the lower right corner of the display 16. Next, the CPU 11 receives “1234” as operation information. Then, the CPU 11 authenticates the target user by determining whether combination information that combines line-of-sight information and operation information in the order received matches setting combination information. Note that the CPU 11 may not display the operation buttons 16A on the display 16 until line-of-sight information is received.

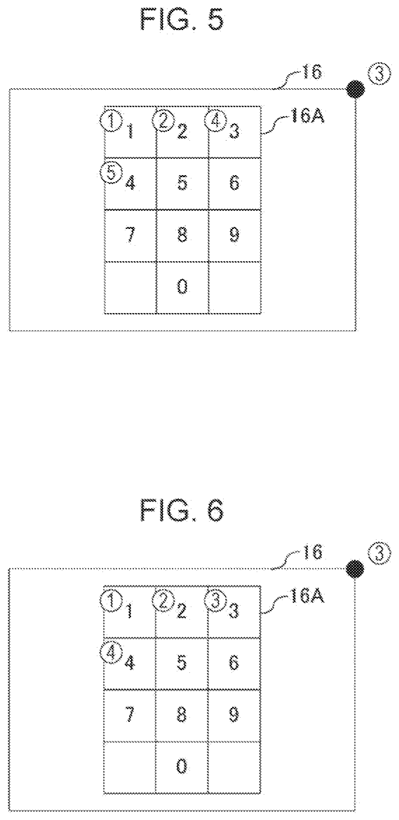

FIG. 5 illustrates an example of the case in which line-of-sight information is set between items of operation information in setting combination information. For example, as illustrated in FIG. 5, the CPU 11 receives “12” as operation information. Then, the CPU 11 receives line-of-sight information in the upper right corner of the display 16. Then, the CPU 11 receives “34” as operation information. Then, the CPU 11 authenticates the target user by determining whether combination information that combines line-of-sight information and operation information in the order received matches setting combination information. Note that setting combination information may be such that operation information is set between items of line-of-sight information.

Here, in the examples illustrated in FIGS. 3 to 5, setting combination information includes no simultaneous information for simultaneously receiving operation information and line-of-sight information. However, these are not the only possible examples. Setting combination information may include simultaneous information for simultaneously receiving operation information and line-of-sight information.

FIG. 6 illustrates an example of the case in which setting combination information includes simultaneous information. For example, as illustrated in FIG. 6, the CPU 11 receives “12” as operation information. Then, the CPU 11 simultaneously receives line-of-sight information in the upper right corner of the display 16 and “3” as operation information. Then, the CPU 11 receives “4” as operation information. Then, the CPU 11 authenticates the target user by determining whether combination information that combines the line-of-sight information and the operation information in the order received matches setting combination information including simultaneous information.

Note that, in the examples illustrated in FIGS. 3 to 6, the CPU 11 may or may not receive line-of-sight information while receiving operation information. In the case where the CPU 11 also receives line-of-sight information while receiving operation information, in the case where the line-of-sight information does not match line-of-sight information included in setting combination information, it is determined that the target user is an authorized user. In contrast, in the case where the CPU 11 also receives line-of-sight information while receiving operation information, in the case where the line-of-sight information matches line-of-sight information included in setting combination information, it is determined that the target user is not an authorized user.

### Second Exemplary Embodiment

In the first exemplary embodiment, the CPU 11 does not change the display form of symbols displayed on the operation buttons 16A. In a second exemplary embodiment, the CPU 11 changes the display form of symbols displayed on the operation buttons 16A.

The hardware configuration of the information processing apparatus 10 according to the second exemplary embodiment is different from the hardware configuration of the information processing apparatus 10 according to the first exemplary embodiment, and setting line-of-sight information and setting operation information are stored in association with each authorized user ID in the user database. Setting line-of-sight information and setting operation information are predetermined by the administrator of the information processing apparatus 10 or the like.

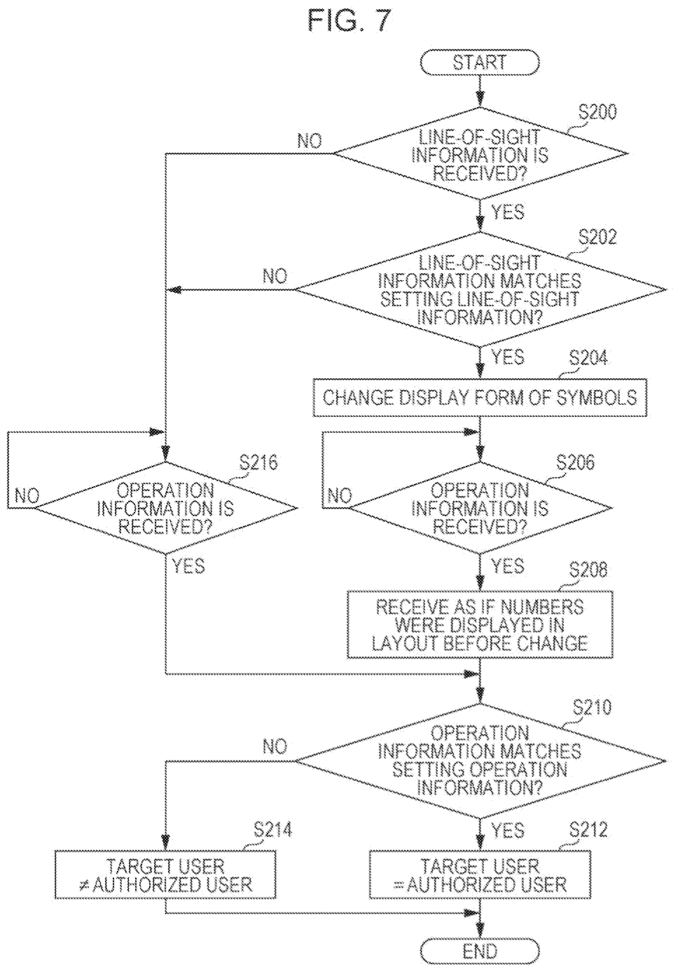

First, with reference to FIG. 7, the flow of information processing in the information processing apparatus 10 of the present exemplary embodiment will be described.

In step S200 in FIG. 7, the CPU 11 determines whether line-of-sight information has been received. In other words, the CPU 11 determines whether line-of-sight information has been received before later-described operation information. On receipt of line-of-sight information (step S200: YES), the CPU 11 moves to step S202.

In step S202, the CPU 11 determines whether the line-of-sight information received in step S200 matches any setting line-of-sight information stored in the user database. In the case where the received line-of-sight information matches setting line-of-sight information (step S202: YES), the CPU 11 moves to step S204. In contrast, in the case where the received line-of-sight information does not match setting line-of-sight information (step S202: NO), the CPU 11 moves to step S216.

In step S204, the CPU 11 changes the display form of symbols displayed on the operation buttons 16A. In the present exemplary embodiment, the CPU 11 changes the layout of numbers as symbols displayed on the operation buttons 16A. Note that the CPU 11 may change the type of symbols. For example, the CPU 11 may change the symbols displayed on the operation buttons 16A from numbers to characters.

In step S206, the CPU 11 waits until receiving operation information input by the target user operating the operation buttons 16A. Specifically, the CPU 11 waits until receiving operation information via the operation buttons 16A. On receipt of operation information (step S206: YES), the CPU 11 moves to step S208.

In step S208, the operation information received in step S206 is received as if numbers were displayed in the layout before the layout is changed in step S204.

In step S210, the CPU 11 determines whether the received operation information matches setting operation information stored in the user database. Specifically, the CPU 11 determines whether the operation information received in step S208 is stored in the user database in association with setting line-of-sight information that matches in step S202. Alternatively, the CPU 11 determines whether the operation information received in step S216 matches any setting operation information stored in the user database. In the case where the received operation information matches setting operation information (step S210: YES), the CPU 11 moves to step S212. In contrast, in the case where the received operation information does not match setting operation information (step S210: NO), the CPU 11 moves to step S214.

In step S212, the CPU 11 determines that the target user is an authorized user. Note that the CPU 11 may display a screen displaying that the target user is permitted to use the information processing apparatus 10 on the display 16. Then, the information processing ends.

In step S214, the CPU 11 determines that the target user is not an authorized user. Note that the CPU 11 may display a screen displaying that the target user is not permitted to use the information processing apparatus 10 on the display 16. Then, the information processing ends.

Returning to step S200, in the case where the CPU 11 receives no line-of-sight information (step S200: NO), the CPU 11 moves to step S216.

In step S216, the CPU 11 waits until receiving operation information input by the target user operating the operation buttons 16A. On receipt of operation information (step S216: YES), the CPU 11 moves to step S210.

Note that, in the case where the CPU 11 receives no line-of-sight information (step S200: NO), or in the case where the received line-of-sight information does not match setting line-of-sight information (step S202: NO), the CPU 11 may move to step S214 without receiving operation information. Specifically, in the case where the CPU 11 receives no line-of-sight information, or in the case where the received line-of-sight information does not match setting line-of-sight information, the CPU 11 may determine that the target user is not an authorized user without receiving operation information.

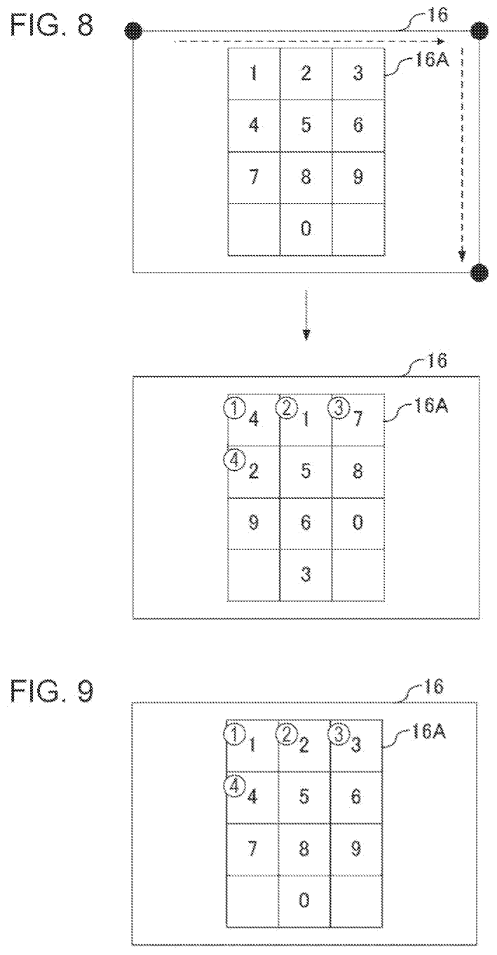

FIG. 8 illustrates an example of the case in which the CPU 11 receives operation information before line-of-sight information. For example, as illustrated in the upper diagram of FIG. 8, the CPU 11 displays “1” in the upper left corner of the operation buttons 16A, “2” next to it, and “3” next to it. Then, the CPU 11 displays “4” below “1” on the operation button 16A, “5” next to it, and “6” next to it. Then, the CPU 11 displays “7” below “4” on the operation button 16A, “8” next to it, and “9” next to it. Then, the CPU 11 displays “0” below “8” on the operation button 16A.

Then, for example, the CPU 11 receives line-of-sight information in the upper left corner of the display 16, then the upper right corner of the display 16, and then the lower right corner of the display 16. In the upper diagram of FIG. 8, dotted arrows indicate the movement of the line of sight of the target user, and black circles indicate positions to which the target user directs the user's line of sight. In the case where line-of-sight information received by the CPU 11 matches setting line-of-sight information, the CPU 11 changes the layout of numbers displayed on the operation buttons 16A. For example, as illustrated in the lower diagram of FIG. 8, the CPU 11 displays “4” on the upper left operation button 16A. “1” next to it, and “7” next to it. Then, the CPU 11 displays “2” below “4” on the operation button 16A, “5” next to it, and “8” next to it. Then, the CPU 11 displays “9” below “2” on the operation button 16A, “6” next to it, and “0” next to it. Then, the CPU 11 displays “3” below “6” on the operation button 16A.

For example, the target user sequentially operates and enters “4”, “1”, “7”, and “2” of the operation buttons 16A. In the lower diagram of FIG. 8, numbers surrounded by circles indicate the order in which the target user has operated the operation buttons 16A. In this case, the CPU 11 receives operation information as if numbers were displayed in the layout before the layout is changed, and thus receives “1234” as operation information. Then, the CPU 11 authenticates the target user by determining whether “1234”, which is the received operation information, matches setting operation information.

FIG. 9 illustrates an example of the case in which the CPU 11 receives no operation information before line-of-sight information, that is, the CPU 11 only receives operation information. For example, the target user sequentially operates and enters “1”, “2”, “3”, and “4” of the operation buttons 16A. In this case, because the CPU 11 does not change the layout of numbers as symbols displayed on the operation buttons 16A, the CPU 11 authenticates the target user by determining whether “1234” as the received operation information matches setting operation information.

Note that, in the above-described example, the CPU 11 changes the layout of symbols displayed on the operation buttons 16A after receiving line-of-sight information. However, this is not the only possible example. The CPU 11 may change the layout of symbols displayed on the operation buttons 16A before receiving line-of-sight information.

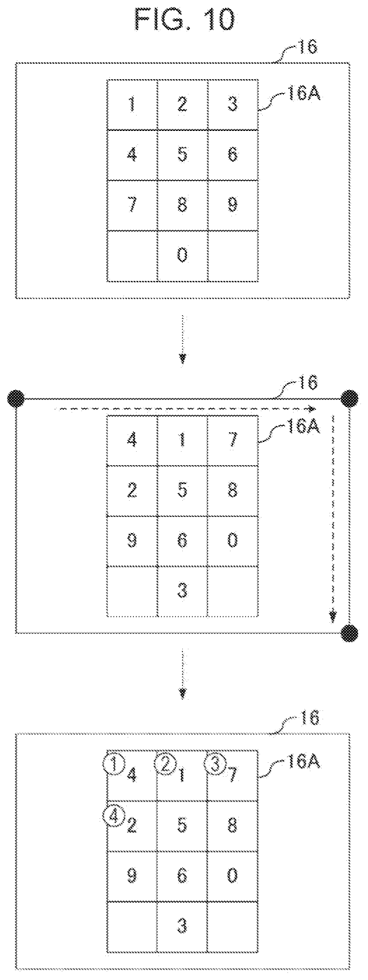

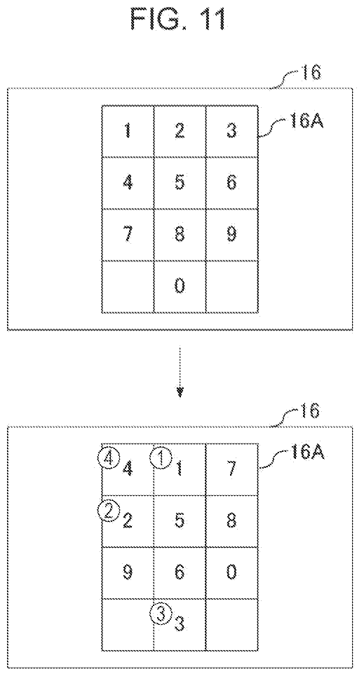

For example, as illustrated in the top diagram of FIG. 10, the CPU 11 displays “1” in the upper left corner of the operation buttons 16A, “2” next to it, and “3” next to it. Then, the CPU 11 displays “4” below “1” on the operation button 16A, “5” next to it, and “6” next to it. Then, the CPU 11 displays “7” below “4” on the operation button 16A, “8” next to it, and “9” next to it. Then, the CPU 11 displays “0” below “8” on the operation button 16A. Then, the CPU 11 changes the layout of symbols displayed on the operation buttons 16A. For example, as illustrated in the second diagram from the top of FIG. 10, the CPU 11 displays “4” on the upper left operation button 16A, “1” next to it, and “7” next to it. Then, the CPU 11 displays “2” below “4” on the operation button 16A, “5” next to it, and “8” next to it. Then, the CPU 11 displays “9” below “2” on the operation button 16A, “6” next to it, and “0” next to it. Then, the CPU 11 displays “3” below “6” on the operation button 16A.

Then, for example, the CPU 11 receives line-of-sight information in the upper left corner of the display 16, then the upper right corner of the display 16, and then the lower right corner of the display 16. In the case where the received line-of-sight information matches setting line-of-sight information, the CPU 11 receives operation information as if numbers were displayed in the layout before the change. For example, as illustrated in the bottom diagram of FIG. 10, the target user sequentially operates and enters “4”, “1”, “7”, and “2” of the operation buttons 16A. In this case, the CPU 11 determines whether “1234” received as operation information matches setting operation information.

In contrast, in the case where the received line-of-sight information does not match setting line-of-sight information, the CPU 11 receives operation information as if numbers were displayed in the layout after the change. For example, as illustrated in the bottom diagram of FIG. 10, in the case where the target user sequentially operates and enters “4”, “1”, “7”, and “2” of the operation buttons 16A, the CPU 11 determines whether “4172” received as operation information matches setting operation information.

In addition, as illustrated in FIG. 11, also in the case where the CPU 11 receives no line-of-sight information, the CPU 11 receives operation information as if numbers were displayed in the layout after the change. For example, as illustrated in the lower diagram of FIG. 11, in the case where the target user sequentially operates and enters “1”, “2”, “3”, and “4” of the operation buttons 16A, the CPU 11 determines whether “1234” received as operation information matches setting operation information.

Note that, in the examples illustrated in FIGS. 10 and 11, in the case where the CPU 11 receives line-of-sight information before operation information, the CPU 11 changes the display form of numbers displayed on the operation buttons 16A. However, these are not the only possible examples. In the case where the CPU 11 receives operation information and line-of-sight information at different times, the CPU 11 may change the display form of numbers displayed on the operation buttons 16A. Specifically, in the case where the CPU 11 receives operation information before line-of-sight information, the CPU 11 may change the display form of numbers displayed on the operation buttons 16A.

In the present exemplary embodiment, the CPU 11 authenticates the target user with line-of-sight information and operation information, irrespective of whether the predetermined condition according to the first exemplary embodiment is satisfied. However, this is not the only possible example. The CPU 11 may authenticate the target user only with operation information in the case where the predetermined condition according to the first exemplary embodiment is satisfied, and may authenticate the target user with line-of-sight information and operation information in the case where the predetermined condition is not satisfied.

### Third Exemplary Embodiment

In the second exemplary embodiment, the same setting operation information is set irrespective of whether the CPU 11 receives line-of-sight information before operation information. In a third exemplary embodiment, as setting operation information, different information is set depending on whether the CPU 11 receives line-of-sight information that matches predetermined setting line-of-sight information before operation information.

The hardware configuration of the information processing apparatus 10 according to the third exemplary embodiment is different from the hardware configuration of the information processing apparatus 10 according to the second exemplary embodiment, and setting line-of-sight information, operation information with the line of sight, and operation information without the line of sight are stored in association with each authorized user ID in the user database. Operation information with the line of sight and operation information without the line of sight are different items of information. In addition, setting line-of-sight information, operation information with the line of sight, and operation information without the line of sight are predetermined by the administrator of the information processing apparatus 10 or the like.

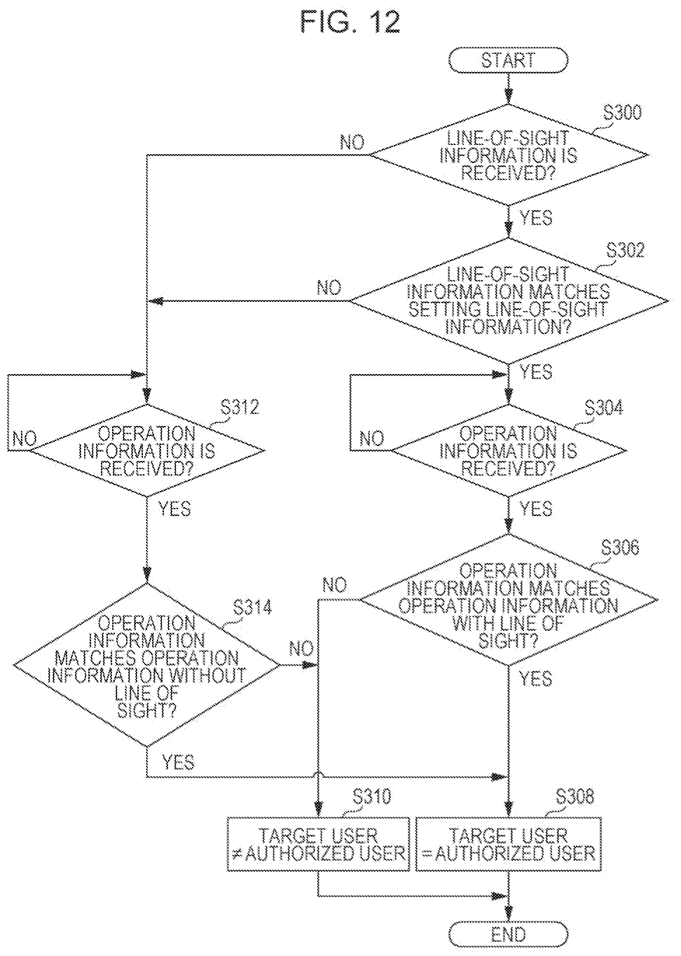

Next, with reference to FIG. 12, the flow of information processing in the information processing apparatus 10 of the present exemplary embodiment will be described.

In step S300 in FIG. 12, the CPU 11 determines whether line-of-sight information indicating a position to which the target user directs the user's line of sight has been received. In other words, the CPU 11 determines whether line-of-sight information has been received before later-described operation information. On receipt of line-of-sight information (step S300: YES), the CPU 11 moves to step S302.

In step S302, the CPU 11 determines whether the line-of-sight information received in step S300 matches any setting line-of-sight information stored in the user database. In the case where the received line-of-sight information matches setting line-of-sight information (step S302: YES), the CPU 11 moves to step S304. In contrast, in the case where the received line-of-sight information does not match setting line-of-sight information (step S302: NO), the CPU 11 moves to step S312.

In step S304, the CPU 11 waits until receiving operation information input by the target user operating the operation buttons 16A. On receipt of operation information (step S304: YES), the CPU 11 moves to step S306.

In step S306, the CPU 11 determines whether operation information received in step S304 matches operation information with the line of sight which is stored in association with setting line-of-sight information that matches in step S302. In the case where the received operation information matches operation information with the line of sight (step S306: YES), the CPU 11 moves to step S308. In contrast, in the case where the received operation information does not match operation information with the line of sight (step S306: NO), the CPU 11 moves to step S310.

In step S308, the CPU 11 determines that the target user is an authorized user. Note that the CPU 11 may display a screen displaying that the target user is permitted to use the information processing apparatus 10 on the display 16. Then, the information processing ends.

In step S310, the CPU 11 determines that the target user is not an authorized user. Note that the CPU 11 may display a screen displaying that the target user is not permitted to use the information processing apparatus 10 on the display 16. Then, the information processing ends.

Returning to step S300, in the case where the CPU 11 receives no line-of-sight information (step S300: NO), the CPU 11 moves to step S312.

In step S312, the CPU 11 waits until receiving operation information input by the target user operating the operation buttons 16A. On receipt of operation information (step S312: YES), the CPU 11 moves to step S314.

In step S314, the CPU 11 determines whether the operation information received in step S312 matches any operation information without the line of sight which is stored in the user database. In the case where the received operation information matches operation information without the line of sight (step S314: YES), the CPU 11 moves to step S308. In contrast, in the case where the received operation information does not match operation information without the line of sight (step S314: NO), the CPU 11 moves to step S310.

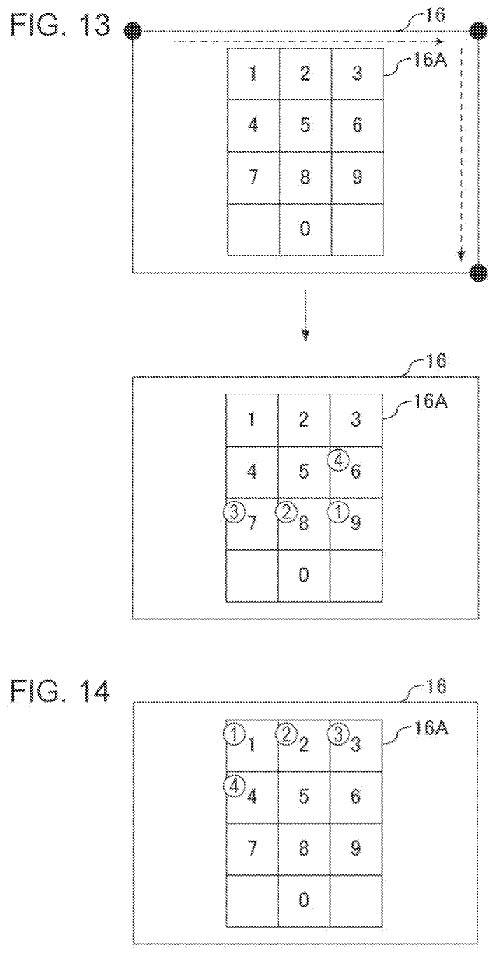

FIG. 13 illustrates an example of the case in which the CPU 11 receives line-of-sight information. For example, as illustrated in the upper diagram of FIG. 13, the CPU 11 receives line-of-sight information in the upper left corner of the display 16, then the upper right corner of the display 16, and then the lower right corner of the display 16. In the upper diagram of FIG. 13, dotted arrows indicate the movement of the line of sight of the target user, and black circles indicate positions to which the target user directs the user's line of sight. Then, in the case where the received line-of-sight information matches setting line-of-sight information, the CPU 11 receives “9876” as operation information. In the lower diagram of FIG. 13, numbers surrounded by circles indicate the order in which the target user has operated the operation buttons 16A. Then, the CPU 11 authenticates the target user by determining whether the received operation information matches operation information with the line of sight which is stored in association with setting line-of-sight information.

Note that operation information with the line of sight may be set for each item of setting line-of-sight information in the user database. For example, operation information with the line of sight in the case where setting line-of-sight information is the upper right corner of the display 16, then the upper left corner of the display 16, and then the lower right corner of the display 16 may be set as “9876”; operation information with the line of sight in the case where setting line-of-sight information is the lower left corner of the display 16, then the upper right corner of the display 16, and then the lower right corner of the display 16 may be set as “0246”; and operation information with the line of sight in the case where setting line-of-sight information is the upper left corner of the display 16, then the upper right corner of the display 16, and then the lower right corner of the display 16 may be set as “1357”.

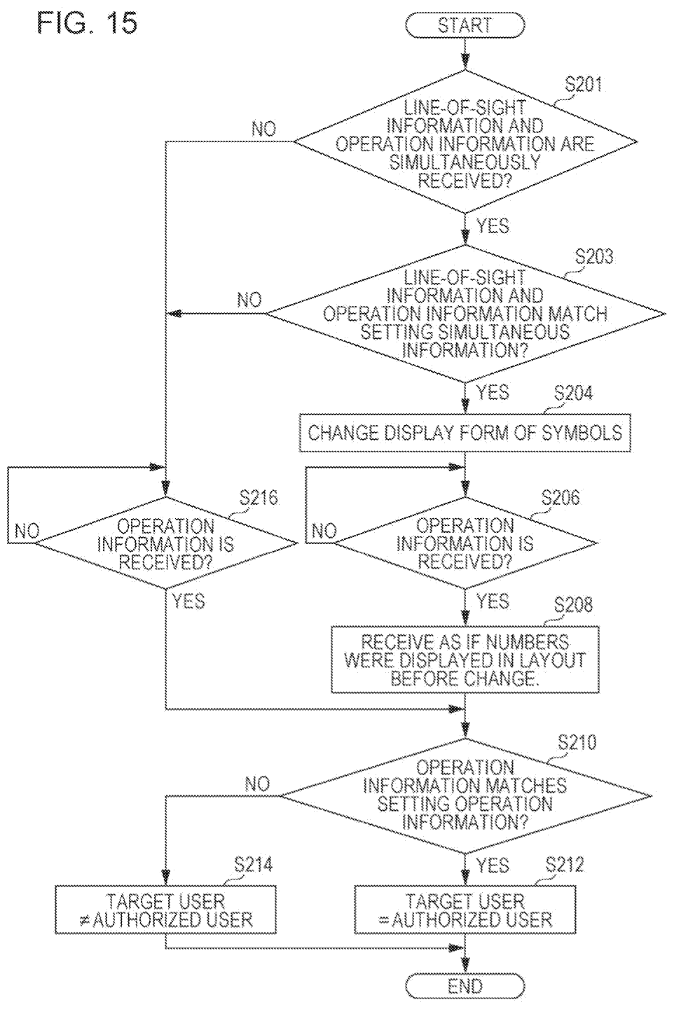

FIG. 14 illustrates an example of the case in which the CPU 11 does not receive line-of-sight information. For example, as illustrated in FIG. 14, the CPU 11 receives “1234” as operation information. Then, the CPU 11 authenticates the target user by determining whether the received operation information matches any operation information without the line of sight.

Note that, in the present exemplary embodiment, the CPU 11 authenticates the target user with line-of-sight information and operation information, irrespective of whether the predetermined condition according to the first exemplary embodiment is satisfied. However, this is not the only possible example. The CPU 11 may authenticate the target user only with operation information in the case where the predetermined condition according to the first exemplary embodiment is satisfied, and may authenticate the target user with line-of-sight information and operation information in the case where the predetermined condition is not satisfied.

Furthermore, in the present exemplary embodiment, different information is set as setting operation information in accordance with whether the CPU 11 has received line-of-sight information that matches the setting line-of-sight information before operation information. However, this is not the only possible example. For example, in the case of authenticating the target user by determining whether line-of-sight information received by the CPU 11 matches predetermined setting line-of-sight information, different information may be set as the setting line-of-sight information depending on whether the CPU 11 has received operation information before line-of-sight information.

### Fourth Exemplary Embodiment

In the second exemplary embodiment, in the case where the CPU 11 receives operation information and line-of-sight information at different times, the CPU 11 changes the layout of symbols displayed on the operation buttons 16A. In a fourth exemplary embodiment, in the case where the CPU 11 simultaneously receives line-of-sight information and operation information, the CPU 11 changes the layout of symbols displayed on the operation buttons 16A.

The hardware configuration of the information processing apparatus 10 according to the fourth exemplary embodiment is different from the hardware configuration of the information processing apparatus 10 according to the second exemplary embodiment, and setting simultaneous information and setting operation information are stored in association with each authorized user ID in the user database. Setting simultaneous information and setting operation information are predetermined by the administrator of the information processing apparatus 10 or the like.

Next, with reference to FIG. 15, the flow of information processing in the information processing apparatus 10 of the present exemplary embodiment will be described. The information processing according to the present exemplary embodiment applies the processing in steps S201 and S203 instead of the processing in steps S200 and S202 of the information processing according to the second exemplary embodiment.

In step S201 in FIG. 15, the CPU 11 determines whether line-of-sight information and operation information have been simultaneously received. On simultaneous receipt of line-of-sight information and operation information (step S201: YES), the CPU 11 moves to step S203. Note that, even in the case where the CPU 11 receives line-of-sight information or operation information before simultaneously receiving line-of-sight information and operation information, the CPU 11 moves to step S203.

In step S203, the CPU 11 determines whether the simultaneous information received in step S201 matches any setting simultaneous information stored in the user database. In the case where the received simultaneous information matches setting simultaneous information (step S203: YES), the CPU 11 moves to step S204. In contrast, in the case where the received simultaneous information does not match setting simultaneous information (step S203: NO), the CPU 11 moves to step S216.

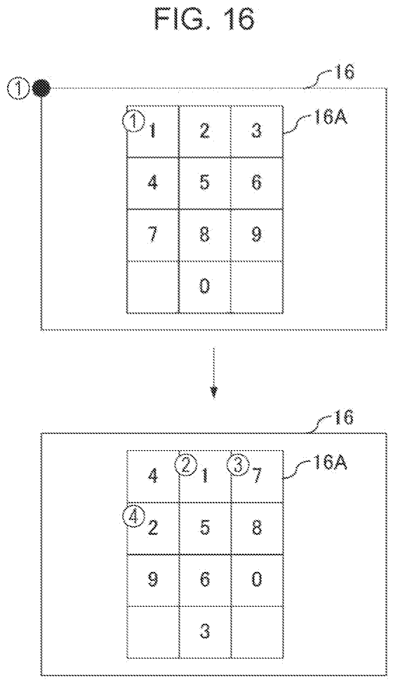

FIG. 16 illustrates an example of the case in which the CPU 11 simultaneously receives line-of-sight information and operation information. For example, as illustrated in the upper diagram of FIG. 16, the CPU 11 displays “1” in the upper left corner of the operation buttons 16A, “2” next to it, and “3” next to it. Then, the CPU 11 displays “4” below “1” on the operation button 16A, “5” next to it, and “6” next to it. Then, the CPU 11 displays “7” below “4” on the operation button 16A, “8” next to it, and “9” next to it. Then, the CPU 11 displays “0” below “8” on the operation button 16A.

Then, when the CPU 11 simultaneously receives line-of-sight information in the upper left corner of the display 16 and “1” as operation information, the CPU 11 determines whether these items of simultaneous information match setting simultaneous information. In the case where the received simultaneous information matches setting simultaneous information, the CPU 11 changes the layout of numbers displayed on the operation buttons 16A. For example, as illustrated in the lower diagram of FIG. 16, the CPU 11 displays “4” on the upper left operation button 16A, “1” next to it, and “7” next to it. Then, the CPU 11 displays “2” below “4” on the operation button 16A, “5” next to it, and “8” next to it. Then, the CPU 11 displays “9” below “2” on the operation button 16A, “6” next to it, and “0” next to it. Then, the CPU 11 displays “3” below “6” on the operation button 16A.

Then, for example, the target user sequentially operates and enters “1”, “7”, and “2” of the operation buttons 16A. In this case, because the CPU 11 receives operation information as if numbers were displayed in the layout before the change, the CPU 11 receives “234” as operation information. In the lower diagram of FIG. 16, numbers surrounded by circles indicate the order in which the target user has operated the operation buttons 16A. Then, the CPU 11 authenticates the target user by determining whether “234”, which is the received operation information, matches setting operation information.

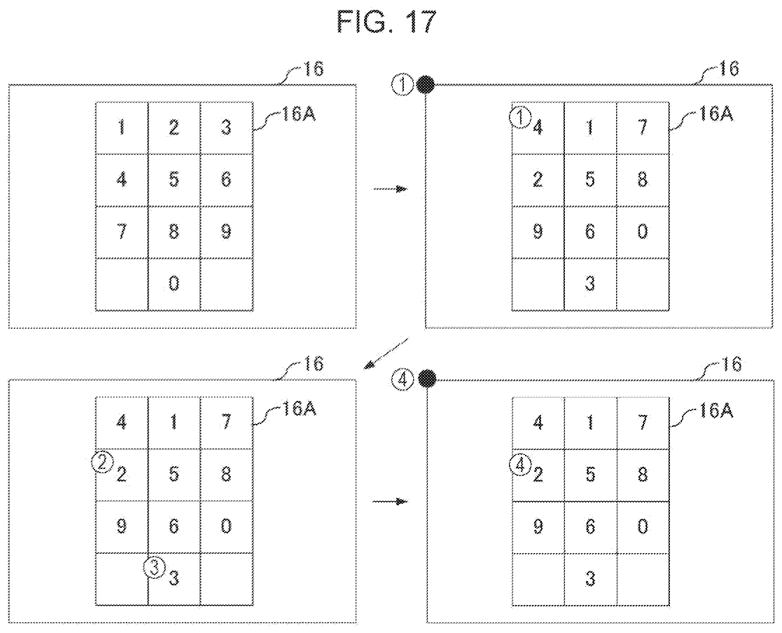

Note that the CPU 11 may simultaneously receive line-of-sight information that matches setting line-of-sight information and operation information after changing the display form of symbols displayed on the operation buttons 16A. For example, as illustrated in the upper left diagram of FIG. 17, the CPU 11 displays “1” in the upper left corner of the operation buttons 16A, “2” next to it, and “3” next to it. Then, the CPU 11 displays “4” below “1” on the operation button 16A, “5” next to it, and “6” next to it. Then, the CPU 11 displays “7” below “4” on the operation button 16A, “8” next to it, and “9” next to it. Then, the CPU 11 displays “0” below “8” on the operation button 16A.

Then, the CPU 11 changes the layout of symbols displayed on the operation buttons 16A. For example, as illustrated in the upper right diagram of FIG. 17, the CPU 11 displays “4” on the upper left operation button 16a, “1” next to it, and “7” next to it. Then, the CPU 11 displays “2” below “4” on the operation button 16A, “5” next to it, and “8” next to it. Then, the CPU 11 displays “9” below “2” on the operation button 16A, “6” next to it, and “0” next to it. Then, the CPU 11 displays “3” below “6” on the operation button 16A.

Then, for example, as illustrated in the upper right diagram of FIG. 17, the target user directs the user's line of sight to the upper left corner of the display 16, and operates and enters “4” of the operation button 16a. In the case where the target user performs these at the same time, and line-of-sight information matches setting line-of-sight information, the CPU 11 receives operation information as if numbers were displayed in the layout before the change. In the example illustrated in the upper right diagram of FIG. 17, the CPU 11 receives “1” as operation information.

In contrast, in the case where the CPU does not receive line-of-sight information that matches setting line-of-sight information, the CPU 11 receives operation information as if numbers were displayed in the layout after the change. For example, in the example illustrated in the lower left diagram of FIG. 17, the CPU 11 receives “23” as operation information.

Then, for example, as illustrated in the lower right diagram of FIG. 17, the target user directs the user's line of sight to the upper left corner of the display 16, and operates and enters “2” of the operation button 16a. In the case where the target user performs these at the same time, and line-of-sight information matches setting line-of-sight information, the CPU 11 receives operation information as if numbers were displayed in the layout before the change. In the example illustrated in the upper right diagram of FIG. 17, the CPU 11 receives “4” as operation information. Then, the CPU 11 authenticates the target user by determining whether information combining “1”, “23”, and “4”, which are received as operation information, in the order received (specifically, “1234”) matches setting operation information.

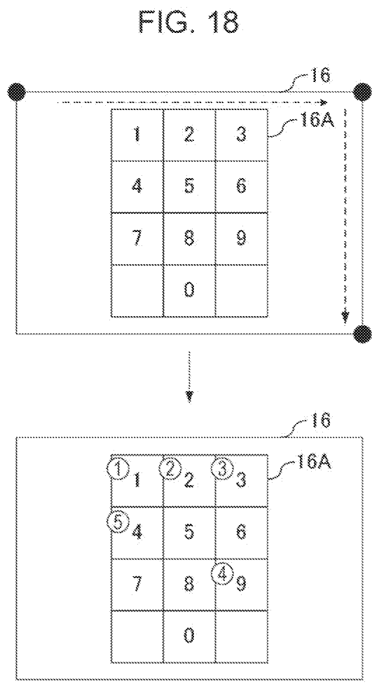

In the case where the CPU 11 receives line-of-sight information that matches setting line-of-sight information, the CPU 11 need not receive predetermined operation information. For example, as illustrated in the upper diagram of FIG. 18, the CPU 11 receives line-of-sight information in the upper left corner of the display 16, then the upper right corner of the display 16, and then the lower right corner of the display 16. In the case where the received line-of-sight information matches setting line-of-sight information, the CPU 11 does not receive “9” as predetermined operation information. In this case, as illustrated in the lower diagram of FIG. 18, even in the case where the target user has operated the operation buttons 16A to enter “12394”, because the CPU 11 does not receive “9”, “1234” is received as operation information. Then, the CPU 11 authenticates the target user by determining whether the received operation information matches setting operation information.

Note that, in this case, there may be multiple items of predetermined operation information. For example, all numbers other than setting operation information (“5”, “6”. “7”, “8”, “9”, and “0” in the example illustrated in FIG. 18) may be applied as predetermined operation information.

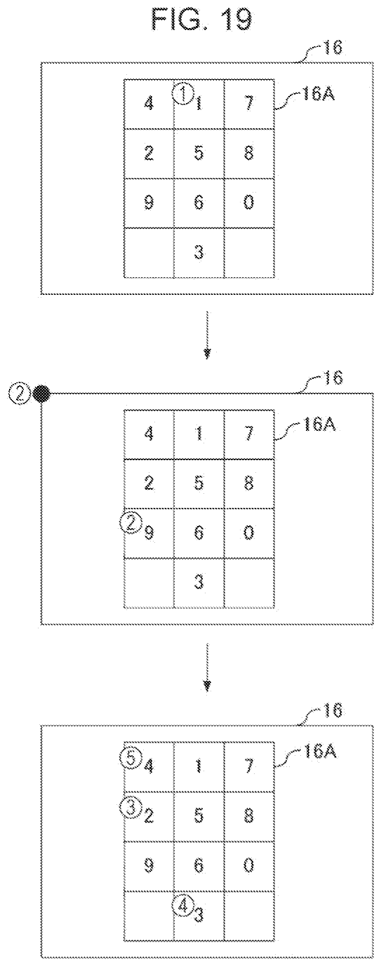

In addition, in the case where the CPU 11 receives line-of-sight information that matches setting line-of-sight information simultaneously as an input of predetermined operation information, the CPU 11 need not receive the predetermined operation information. For example, as illustrated in the top diagram of FIG. 19, in the case where the target user inputs “1” as operation information, and the CPU 11 does not simultaneously receive line-of-sight information that matches setting line-of-sight information, the CPU 11 receives “1” as operation information. Then, as illustrated in the second diagram from the top of FIG. 19, in the case where the target user inputs “9” as predetermined operation information, and the CPU 11 simultaneously receives line-of-sight information directed to the upper left corner of the display 16 which matches setting line-of-sight information, the CPU 11 does not receive “9” as the predetermined operation information. Then, as illustrated in the bottom diagram of FIG. 19, in the case where the target user inputs “234” as operation information, and the CPU 11 does not simultaneously receive line-of-sight information that matches setting line-of-sight information, the CPU 11 receives “234” as operation information. Then, the CPU 11 authenticates the target user by determining whether “1234”, which combines “1” and “234”, which are the received operation information, in the order received matches setting operation information.

Note that, in the present exemplary embodiment, the CPU 11 authenticates the target user with line-of-sight information and operation information, irrespective of whether the predetermined condition according to the first exemplary embodiment is satisfied. However, this is not the only possible example. The CPU 11 may authenticate the target user only with operation information in the case where the predetermined condition according to the first exemplary embodiment is satisfied, and may authenticate the target user with line-of-sight information and operation information in the case where the predetermined condition is not satisfied.

Although the above exemplary embodiments have been described, the technical scope of the present disclosure is not limited to the scope described in the above-described exemplary embodiments. Various changes or improvements may be made to the above-described exemplary embodiments to the extent that they do not deviate from the gist of the present disclosure, and forms in which the changes or improvements are made are also included in the technical scope of the present disclosure.

Furthermore, the above-described exemplary embodiments are not construed as limiting the aspects of the disclosure according to the claims, and not all of the combinations of features described in the exemplary embodiments are necessary for the solution of the disclosure. The above-described exemplary embodiments include aspects of the disclosure in various stages, and various aspects of the disclosure are extracted by combining the disclosed components. Even if some components are removed from all components discussed in the exemplary embodiments, as far as the effect is obtained, a configuration in which some components are removed may be extracted as an aspect of the disclosure.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

Although the form in which the information processing program is installed in the ROM 12 or the storage 14 has been described in the above-described exemplary embodiments, this is not the only possible form. The information processing program according to the above-described exemplary embodiments may be provided in a form recorded on a computer-readable storage medium. For example, the information processing program according to the above-described exemplary embodiments may be provided in a form recorded on an optical disk such as a compact disc (CD)-ROM or a digital versatile disc (DVD)-ROM, or in a form recorded on a semiconductor memory such as Universal Serial Bus (USB) memory and a memory card. Moreover, the information processing program according to the above-described exemplary embodiments may be obtained from an external apparatus via the communication I/F 17.

Although the case in which processing in the information processing apparatus 10 is realized by a software configuration using a computer by executing a program has been described in the above-described exemplary embodiments, the present disclosure is not limited thereto. For example, processing in the information processing apparatus 10 may be realized in the form of a hardware configuration or a combination of a hardware configuration and a software configuration.

In addition, the configuration of the information processing apparatus 10 described in the above-described exemplary embodiments is an example, and it goes without saying that unnecessary portions may be removed or new portions may be added within a range that does not deviate from the spirit of the present disclosure.

Moreover, the flow of processing in the information processing apparatus 10 described in the exemplary embodiments is an example, and it goes without saying that unnecessary steps may be removed, new steps may be added, or the processing order may be changed within a range that does not deviate from the spirit of the present disclosure.

Furthermore, the present disclosure is not limited to the above, and it goes without saying that, in addition to the above, various modifications can be implemented within a range that does not deviate from the spirit thereof.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

An information processing apparatus including:
a processor configured to:
   receive line-of-sight information indicating a position to which a user directs the user's line of sight, and operation information input by the user operating operation buttons; and
   authenticate the user with the received line-of-sight information and the received operation information.
      (((2)))

The information processing apparatus according to (((1))), wherein the processor is configured to authenticate the user by determining whether combination information that combines the line-of-sight information and the operation information in an order received matches predetermined setting combination information.

(((3)))

The information processing apparatus according to (((1))) or (((2))), wherein the processor is configured to receive the operation information and the line-of-sight information at different times.

(((4)))

The information processing apparatus according to (((3))), wherein, in a case where the line-of-sight information is received before the operation information and the line-of-sight information matches predetermined setting line-of-sight information, the processor is configured to change a display form of symbols displayed on the operation buttons.

(((5)))

The information processing apparatus according to (((4))), wherein the processor is configured to change the display form by changing a layout of symbols displayed on the operation buttons.

(((6)))

The information processing apparatus according to (((5))), wherein the processor is configured to receive the operation information as if the symbols were displayed in the layout before the change even after the layout of the symbols has been changed.

(((7)))

The information processing apparatus according to (((1))) or (((2))), wherein the processor is configured to simultaneously receive the operation information and the line-of-sight information.

(((8)))

The information processing apparatus according to (((7))), wherein, in a case where the operation information and the line-of-sight information are simultaneously received and the line-of-sight information matches predetermined setting line-of-sight information, the processor is configured to change a display form of symbols displayed on the operation buttons.

(((9)))

The information processing apparatus according to any one of (((1))) to (((8))), wherein:
the processor is configured to:
   authenticate the user only with the received operation information in a case where a predetermined condition is satisfied; and
   authenticate the user with the received line-of-sight information and the received operation information in a case where the predetermined condition is not satisfied.
      (((10)))

The information processing apparatus according to (((9))), wherein the predetermined condition is a condition that no one else other than the target user is able to see the operation buttons.

(((11)))

An information processing program causing a computer to execute a process, the process including:
receiving line-of-sight information indicating a position to which a user directs the user's line of sight, and operation information input by the user operating operation buttons; and
authenticating the user with the received line-of-sight information and the received operation information.

What is claimed is:

1. An information processing apparatus comprising:
a processor configured to:
receive line-of-sight information indicating a position to which a user directs the user's line of sight, and operation information input by the user operating operation buttons; and
authenticate the user with the received line-of-sight information and the received operation information.

2. The information processing apparatus according to claim 1, wherein the processor is configured to authenticate the user by determining whether combination information that combines the line-of-sight information and the operation information in an order received matches predetermined setting combination information.

3. The information processing apparatus according to claim 1, wherein the processor is configured to receive the operation information and the line-of-sight information at different times.

4. The information processing apparatus according to claim 3, wherein, in a case where the line-of-sight information is received before the operation information, the processor is configured to change a display form of symbols displayed on the operation buttons.

5. The information processing apparatus according to claim 4, wherein the processor is configured to change the display form by changing a layout of symbols displayed on the operation buttons.

6. The information processing apparatus according to claim 5, wherein the processor is configured to receive the operation information as if the symbols were displayed in the layout before the change even after the layout of the symbols has been changed.

7. The information processing apparatus according to claim 1, wherein the processor is configured to simultaneously receive the operation information and the line-of-sight information.

8. The information processing apparatus according to claim 7, wherein, in a case where the operation information and the line-of-sight information are simultaneously received, the processor is configured to change a display form of symbols displayed on the operation buttons.

9. The information processing apparatus according to claim 1, wherein:
the processor is configured to:
authenticate the user only with the received operation information in a case where a predetermined condition is satisfied; and
authenticate the user with the received line-of-sight information and the received operation information in a case where the predetermined condition is not satisfied.

10. The information processing apparatus according to claim 9, wherein the predetermined condition is a condition that no one other than the user is able to see the operation buttons.

11. A non-transitory computer readable medium storing a program causing a computer to execute a process, the process comprising:
receiving line-of-sight information indicating a position to which a user directs the user's line of sight, and operation information input by the user operating operation buttons; and
authenticating the user with the received line-of-sight information and the received operation information.

12. An information processing method comprising:
receiving line-of-sight information indicating a position to which a user directs the user's line of sight, and operation information input by the user operating operation buttons; and
authenticating the user with the received line-of-sight information and the received operation information.
